(19) United States
(12) Patent Application Publication
(10) Pub. No.: US 2013/0030645 A1
(43) Pub. Date: Jan. 31, 2013

(54) AUTO-CONTROL OF VEHICLE INFOTAINMENT SYSTEM BASED ON EXTRACTED CHARACTERISTICS OF CAR OCCUPANTS

(71) Applicants: Lucas Divine, San Jose, CA (US); Junnosuke Kurihara, Milpitas, CA (US); David Kryze, Campbell, CA (US)

(72) Inventors: Lucas Divine, San Jose, CA (US); Junnosuke Kurihara, Milpitas, CA (US); David Kryze, Campbell, CA (US)

(73) Assignee: PANASONIC CORPORATION, Osaka (JP)

(21) Appl. No.: 13/192,629

(22) Filed: Jul. 28, 2011

(51) Int. Cl. G06F 15/16; G06F 7/00

(52) U.S. Cl. 701/36; 709/217

(57) ABSTRACT

An infotainment system is provided for delivering content to multiple occupants of a vehicle. The infotainment system includes: an occupant detector configured to receive characteristic data for occupants of the vehicle and generate a profile for each occupant of the vehicle; a recommendation engine that analyzes the profiles of the vehicle occupants; and a content delivery engine that deliver content to one or more of the vehicle occupants in accordance with the analysis of the profiles of the vehicle occupants.

### FIELD

The present disclosure relates generally to a vehicle infotainment system and, more particularly, to an automated control algorithm for recommending and administering content delivery to vehicle occupants.

### BACKGROUND

Vehicle information and entertainment systems are becoming more prevalent in the marketplace (referred to herein as infotainment systems). Beyond radios and navigation devices, today's vehicles are equipped to video players, game consoles, multiple displays, external networking connections and more. These types of features are controlled traditionally by their users. What is lacking is a more automated manner of controlling these devices and the content they deliver to the vehicle occupants.

Furthermore, certain content may not be suitable for consumption by all of the vehicle occupants or playable by all audio/visual equipment in various locations in the vehicle. In such cases, it is desirable for the system to determine the interpersonal relationships amongst the occupants and provide recommendations regarding content or delivery thereof in accordance with the interpersonal relationships of the vehicle occupants. This section provides background information related to the present disclosure which is not necessarily prior art.

### SUMMARY

An infotainment system is provided for delivering content to multiple occupants of a vehicle. The infotainment system includes: an occupant detector configured to receive characteristic data for occupants of the vehicle and generate a profile for each occupant of the vehicle; a recommendation engine that analyzes the profiles of the vehicle occupants; and a content delivery engine that deliver content to one or more of the vehicle occupants in accordance with the analysis of the profiles of the vehicle occupants.

Characteristic data for occupants may be received from one or more sources, including sensors disposed in the vehicle, an occupant's mobile computing device in data communication with the infotainment system and a personal profile of an occupant retrieved remotely from a data source outside the vehicle.

Based on the analysis of profiles, the content delivery engine can change the content being delivered and/or change delivery medium for content being delivered via the infotainment system.

In one aspect of the disclosure, the recommendation engine determine seat positions for each occupant and the content delivery engine delivers content to one or more of the vehicle occupants in accordance with the seat positions of the vehicle occupants.

In another aspect, the recommendation engine determines an interpersonal relationship between the two or more occupants and the content delivery engine delivers content to one or more of the vehicle occupant in accordance with the interpersonal relationship.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a diagram depicting an exemplary construct for an infotainment system residing in a vehicle;

FIG. 2 is a diagram illustrating an exemplary layout of sensors in a car;

FIG. 3 is a high level flowchart of an exemplary automated control algorithm for recommending and administer content delivery to vehicle occupants;

FIG. 4 is a flowchart illustrating an exemplary method for formulating content suggestions;

FIG. 5 is a diagram of an exemplary scheme for maintaining a vehicle occupant map;

FIG. 6 is a block diagram depicting software modules for implementing the automated control algorithm;

FIG. 7 is a flowchart illustrating an exemplary method for checking conflicts for content recommendations;

FIG. 8 is a flowchart illustrating an exemplary method for implementing content recommendations;

FIG. 9 illustrates an exemplary interface for displaying content recommendations;

FIG. 10 is a flowchart

FIG. 11A-11C illustrate exemplary use cases for managing privacy;

FIGS. 12A and 12B illustrate an exemplary use case for sharing content;

FIGS. 13A and 13B illustrate exemplary use case for location specific content recommendations; and

FIGS. 14A and 14B illustrate another exemplary use case for content recommendations.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

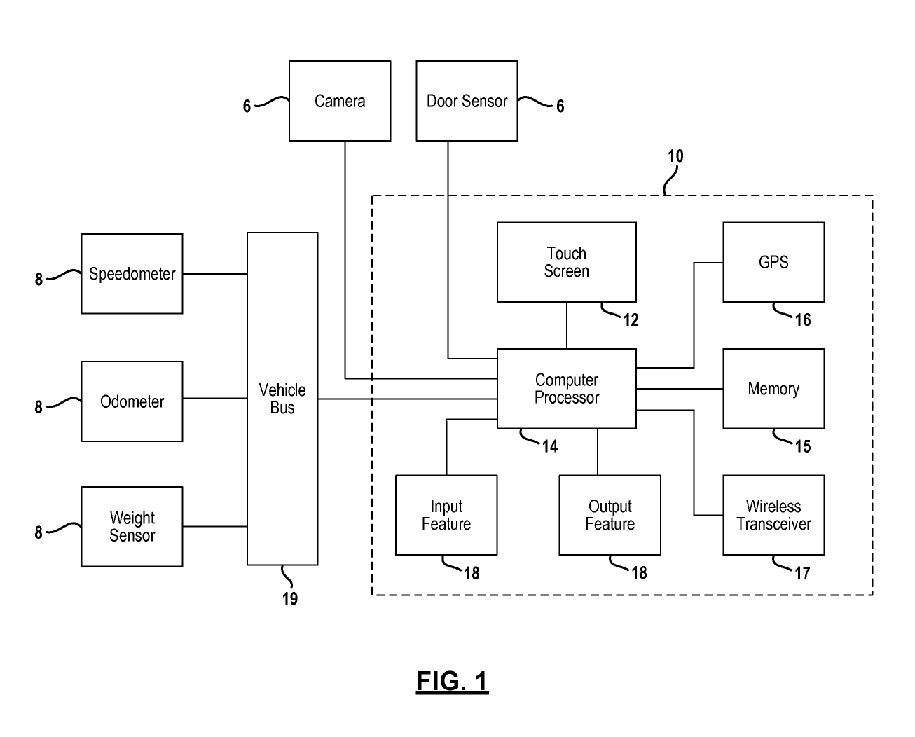

FIG. 1 illustrates a basic construct for an infotainment system 10 residing in a vehicle. The infotainment system 10 is comprised of a user display 12, a computer processor 14, a computer memory 15, a global positioning system (GPS) device (which can include assisted GPS technology for faster location detection) 16, one or more wireless transceivers 17 and a plurality of input or output features 18, such as buttons, speakers, microphones, etc. The infotainment system 10 may be integrated into the dashboard of vehicle and receive inputs from other vehicle sensors or subsystems as further described below. While the following description is provided with reference to a vehicle, it is understood that broader aspects of the disclosure are applicable to an infotainment system residing in other shared spaces such as conference rooms, cottages, hotels rooms, airplane, etc.

The computer memory 15 includes storage for algorithms contemplated herein, content usage history, and passenger profile information (which can include passenger history). The storage of such items can be in a database or other data structure arrangement.

Wireless transceiver 17 can include Near Field Communications (NFC), Bluetooth, LTE, HSPA+, 802.11(a, g, n), Zigbee, or other wireless communication technologies. These allow both the car to communicate with remote systems via a wide area network such as the internet and also communicate with local computing devices of vehicle occupants (smartphones, laptops, etc.). The vehicle also may include wired connections that allow local occupant computing devices to be plugged into the car for additional communication and device battery charging.

The infotainment system 10 is further configured to receive inputs from additional sources. First, the infotainment system 10 receives inputs from conventional vehicle sensors 8, such as a speedometer, an odometer, a fuel tank sensor, etc. In one example, weight of a vehicle occupant is determined from weight sensors disposed in the each vehicle seat. The weight sensors may be part of a vehicle safety subsystem and interfaced via the vehicle bus or internal communication network 19 to the infotainment system 10. In another example, a sensor is placed in the headrest of a seat in order to detect height of a user. The headrest sensor can also be used to detect and/or sync up with child seats for detection of additional occupant characteristics. Inputs from other types of sensors are contemplated by this disclosure.

The vehicle may be further configured with additional sensors 6 for capturing characteristics of vehicle occupants. For example, the vehicle may be equipped with one or more cameras that can be used to detect facial images of the vehicle occupants. Facial recognition algorithms can then be applied to the facial images from the cameras to determine an identity or mood of a vehicle occupant. In another example, microphones positioned proximate to each seat can captured voice input. Voice recognition algorithms can then be applied to captured voice data to determine the identity, tone, mood, or linguistic background of the vehicle occupant. In yet another example, doors of the vehicle may be equipped with capacitive sensors that can read capacitive signatures of persons opening the door. Other types of biometric sensors and sensing schemes may be employed to determine the identity of vehicle occupants. It is understood that the different sensors discussed above may interface directly with the system or via the vehicle bus depending upon whether the sensors are provided by the vehicle manufacturer or are aftermarket components.

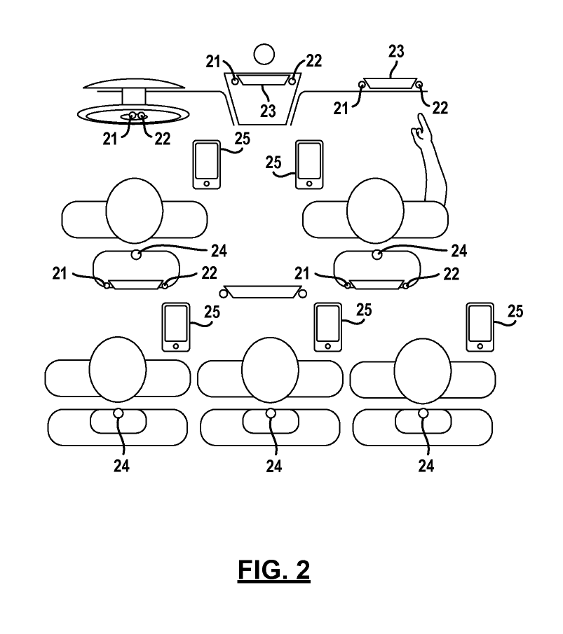

FIG. 2 illustrates an exemplary layout of sensors in a car. Multiple sensors are located according to where each occupant sits in the vehicle. For example, a camera 21 and a microphone 22 for a driver may be disposed in the steering wheel of the vehicle; whereas, a camera 21 and a microphone 22 for the other occupants may be disposed adjacent to a display 23 positioned directly in front of the respective occupant. Input ports or docking stations 25 for mobile computing devices may also be positioning adjacent to each vehicle seat. In another example, a pressure sensor 24 is disposed in the headrest of each vehicle seat to detect occupant presence. It is readily understood that different types of sensors may be disposed throughout the vehicle compartment in any manner that does not impede their function. Sensor placement enables the infotainment system 10 to determine location of each occupant within the vehicle and adapt content delivery in accordance with location information. For instance, if an occupant chose to play a game that will benefit from other players joining in, the infotainment system will find other occupants that will most likely want to play the same game and/or select the game based on the location of other players. Certain cooperative games would be more difficult to play if one player is sitting in front of another player; whereas, other games would prefer players be separated from each other in the vehicle.

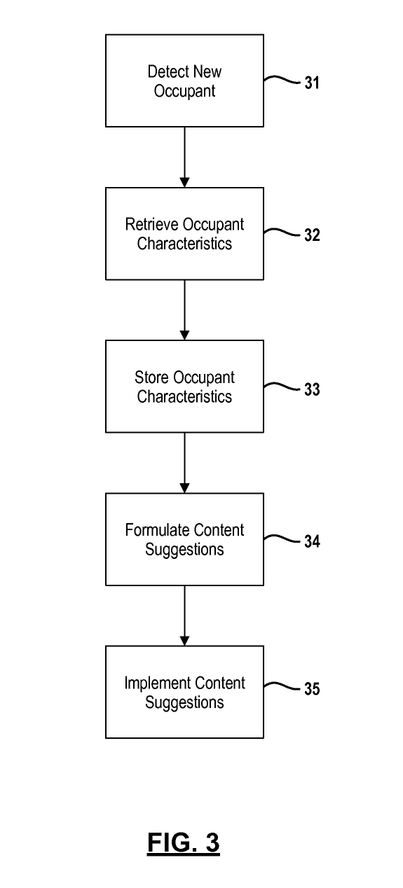

With reference to FIG. 3, the infotainment system employs an automated control algorithm to recommend and administer content delivery to vehicle occupants. In an exemplary embodiment, the control algorithm is initiated each time a new occupant enters the vehicle as indicates at 31. Presence of a new occupant may be detected in various ways including the use of a camera, one or more optical infrared sensors and/or weight sensors (employing resistive and/or capacitive sensing techniques) disposed in the vehicle seats. The accuracy of such detection is improved with detecting the opening and closing of a door. In an additional exemplary embodiment, the control algorithm is initiated upon a user input request. In an additional exemplary embodiment, the control algorithm is initiated upon an event, such as a telephone call being completed in the vehicle. It is envisioned that the control algorithm may be initiated from other triggers or executed periodically.

Upon detecting the new occupant, the control algorithm will first identify the occupant and retrieve any available characteristics about the occupant as indicated at 32. Occupant characteristics can be retrieved from a variety of sources. For example, characteristics for an occupant can be determined or derived from input from one or more in-vehicle sensors as noted above.

In another example, the occupant may carry a personal mobile computing device, such as a phone, a smartphone, a portable media player, a handheld global positioning device, a laptop computer, etc. Such computing devices may be queried by the infotainment system to gather information about the occupant. In some instances, the queried information can be identifying information for the device user. Queried information may further include media content residing on the device, such as music, movies, podcasts and the like, as well as applications residing on the device or used by the occupant, such as newspapers, games, social networks, and the like. The infotainment system may also query past media consumption including partial consumption (e.g., two of three rear seat passengers have started watching but did not finish a particular TV episode). Mobile computing devices may also provide phone contacts, email, and schedule of occupants. Schedule of occupants is important in the vehicle context as the control algorithm can suggest preparatory content or activity for upcoming meetings or next up event. For example, if a meeting is upcoming in 30 minutes and the meeting request in the person's calendar has an attached agenda or other content, the control algorithm can use such information to give high priority to display or output of such related and time sensitive information. Mobile computing devices may be interface with the infotainment system via a wireless data link (e.g., Bluetooth) or a wired connection to an input port of a docking station. The use of docking stations is a good technique for associating the user of the mobile device with the user's location in the vehicle.

In yet another example, characteristics for an occupant can be determined or derived from a personal profile or other information retrieved from a remote data source, such as a web server, outside the vehicle. Persons routinely post information about themselves, such as who they work for, movies they like, food or restaurants they like (which the control algorithm can use to suggest restaurants on the planned travel route), other persons they know and the like, on blogs or social networking sites. In one implementation, such information can be retrieved using a search engine via a cellular or satellite data link by the infotainment system. Another of user characteristics accessible online are comments and logs of previous locations they have been to or services they have used on review sites or geotagging websites. Other types of data sources are contemplated by this disclosure.

One additional feature of the system is to identify occupants who may not be as tech-savvy by building the occupant history of not having or using a personal mobile computing device. A tag can be added to such a user's control algorithm history as a user who prefers simple interaction. The system may ask this type of user to input some helpful characteristics directly into the infotainment system because the system cannot locate as much about them from their device or internet profiles.

Regardless of the source type, characteristics about an occupant are accumulated and stored locally at 33 in a database for subsequent processing. Such processing includes updating a history database to keep current the user profiles of occupants and non-occupants. This provides current, past, and future (e.g. future scheduled appointments) profiles of vehicle participants. An exemplary user profile may include content such as “User=Bob”—“current preferred option=silence”—“music=metal, then rock, then blues”—“business=Panasonic”—“geologger=no”—“yelp reviewer=yes, likes Tony's pizza, dislikes Holiday Inn”—“mood=frown”—“voice=quiet”—“family member=Father” “temperature=cool”. Various types of data structures for storing user profiles are contemplated by this disclosure.

From the recently acquired occupant characteristics and stored profile information, the infotainment system can formulate at 34 suggestions regarding content selection and/or content delivery. An exemplary use case may involve a child playing loud rap music while alone in the vehicle. When a parent enters the car, music being played in the vehicle is changed automatically to a genre enjoyed by both parent and child such as classic rock. In another exemplary use case, user profiles for the vehicle occupants indicate each occupant enjoys playing a particular game (e.g., Scrabble), where the user preference was learned from a social media site (e.g., “likes” on Facebook). The system may in turn recommend that occupants play this particular game. The system may further operate to download the particular game from a software application source external to the vehicle if not currently available in the vehicle's local repository. Content suggestions are implemented at 35 either automatically or in response to user selection as further described below.

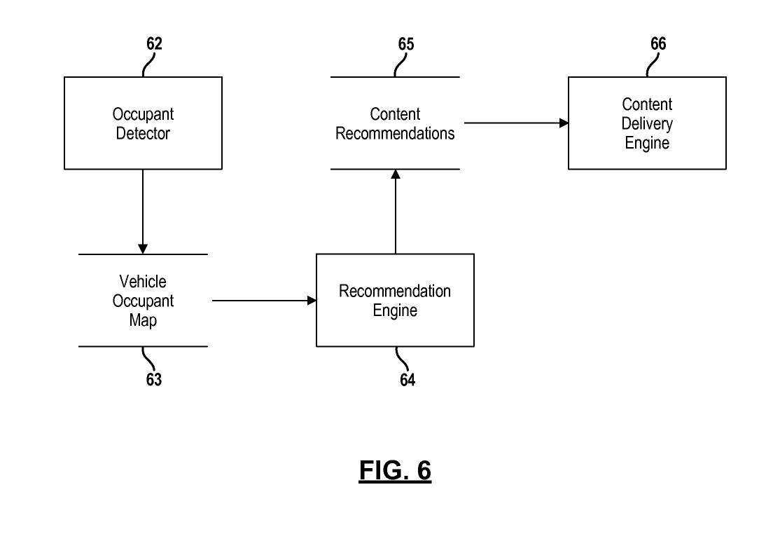

Functionality of the control algorithm may be divided amongst different software modules as shown in FIG. 6. An occupant detector 62 receives characteristic data from various in-vehicle sensors and generates a profile for each vehicle occupant based on the characteristic data. The resulting output from the occupant detector 62 is expressed in a vehicle occupant map 63 which includes profile data for each vehicle occupant as further described below. A recommendation engine 64 formulates content recommendations from the vehicle occupant map and outputs a listing of content recommendations 65. The content delivery engine 66 in turn delivers content to the vehicle occupants using the listing of content recommendations. In one exemplary embodiment, each of these modules is implemented as computer-executable instructions residing in the computer memory 15 and executed by the computer processor of the infotainment system 10.

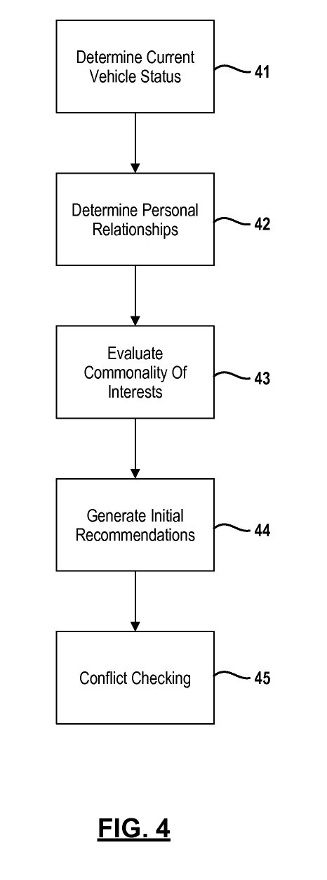

FIG. 4 further illustrates an exemplary method for formulating content suggestions. Current vehicle status is determined first at 41. In one embodiment, current vehicle status is expressed as a vehicle occupant map. For the vehicle, the vehicle occupant map may include information of the current itinerary, a designation of the relationship amongst the current occupants as well as a designation for the overall vehicle atmosphere or mood. For each seat position in the vehicle, an exemplary occupant map may include occupant status (e.g., occupied or vacant), occupant identity, relationship with driver or other occupants, anticipated and/or actual time entering vehicle, anticipated and/or actual time exiting vehicle, device availability and current interests. Device availability is a listing of devices available to an occupant at a particular seat position, where the listing includes personal mobile devices brought into the vehicle by the occupant as well as devices integrated into the vehicle. The vehicle occupant map is built dynamically when a first occupant enters the vehicle. The vehicle occupant map is thereafter updated and maintained when a new occupant enters the vehicle or when new information becomes available to the infotainment system.

In another more robust embodiment, the current vehicle status may include additional vehicle information. For example, the control algorithm may query the current graphical user interface (GUI mode of the vehicle. Various GUI modes may be tailored to specific users with skins, text size, voice vs. touch control, and other types of car friendly GUI modes. The current GUI mode provides the algorithm with an indication of what GUI mode to propose in the content suggestion hierarchy list.

The control algorithm may also query the current content being used in the car at the various input/output locations (e.g. shown in FIG. 2). Current content is another indicator of what type of content should be recommended. Some passengers may not be using a car infotainment device, but may be using their own portable electronic device to experience content. In addition, some users may not be using any electronic equipment, but may be reading a physical book or sleeping, which can be detected with camera 21, for example. How content is being consumed by the different occupants is another factor used to recommend content or delivery thereof. Likewise, a user's direct request (voice, buttons, gesture) for certain content can be taken into account with high priority, although certain conflicts and other considerations may prevent accommodating the user's direct request.

The control algorithm may further query additional vehicle status information that may allow certain mode types to be recommended over others. Internal car temperature, external car temperature, window up/down location information, car velocity, car acceleration, car gear, navigation device destination, time of day, car layout of AV equipment, and other sensor data is collected and used to formulate content recommendations.

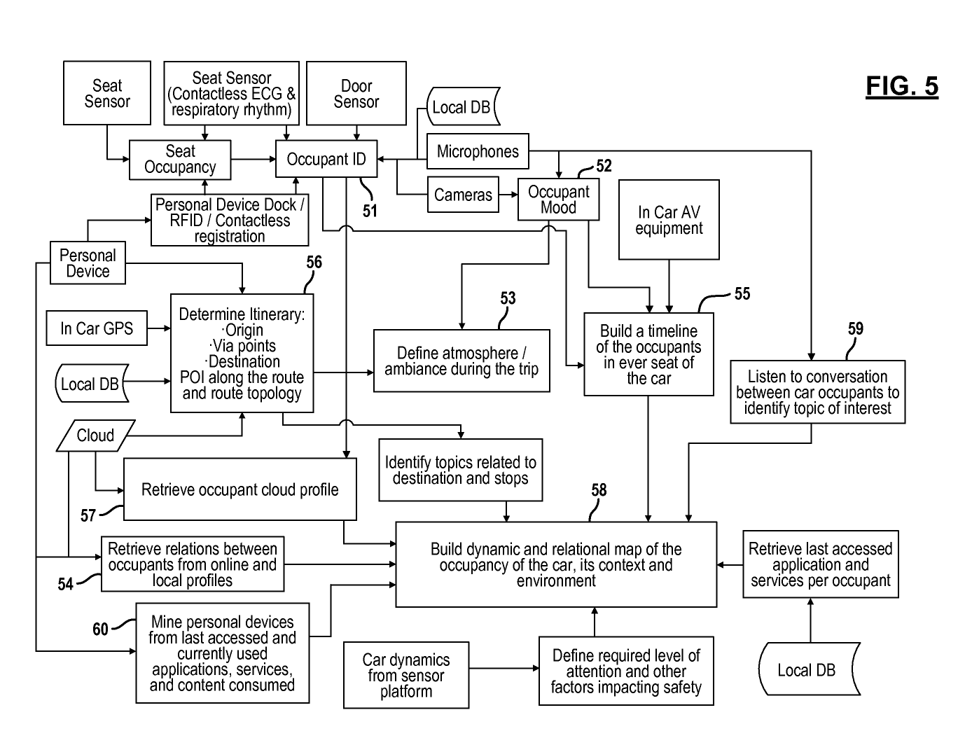

An exemplary scheme for maintaining the vehicle occupant map is depicted in FIG. 5. An occupant's identity and their associated seat position may be determined at 51 from various inputs, such as door sensors, seat sensors, microphones, cameras and personal mobile devices as discussed above. Input from the microphone and/or cameras may also be used to determine an occupant's mood as indicated at 52. Mood of a laughing occupant is designated as happy; whereas, mood of a crying occupant is designated as sad. From the mood of each occupant, an overall atmosphere of the vehicle may be classified at 53. Moods and/or atmosphere status can in turn be used as factors when recommending content or content delivery.

Given an occupant's identity, the occupant's relationship with the other occupants is retrieved or otherwise determined as indicated at 54. In one exemplary embodiment, the driver classifies the relationship with each new occupant as they enter the vehicle. In an alternative embodiment, the relationship may be determined automatically from an occupant's profile retrieved from a social network. More advanced techniques of acquiring relationship information are contemplated and may include inferring relationships from conversations between occupants using known artificial intelligent technology. An occupant's relationship may be defined in relation to the vehicle driver or owner, such as spouse, child, parent, cousin, co-worker, friend, etc. Once a relationship between two persons has been determined, this relationship is stored locally, along with other identifying information for the occupant, for subsequent use by the infotainment system.

When a new occupant enters the vehicle, the stored relationships are retrieved and used to update the relationship field for the occupant in the occupant map. If the new occupant is not identified with a certain confidence level or their relationship to the other occupants in unknown, the occupant's relationship designation may be set to a “polite” mode. In a polite mode, content delivery may be defaulted to playing jazz music at a low volume. Jazz content could be retrieved from a driver's portable device or from a local radio station. Privacy settings may be set to high so email delivery is terminated. And any online profiles containing personal information are logged off. In the polite mode, the occupant detector 62 would actively monitor and record characteristic data for the new occupant; whereas, in other modes, the occupant detector 62 may discontinue such monitoring activities once each occupant is positively identified.

Maintaining the vehicle occupant map may include building a timeline of when seats are occupied or anticipated to be occupied as indicated at 55. In addition to actual entry and exit times, the automated control algorithm may learn anticipated entry and exit times for occupants. For example, the system may learn anticipated entry and exit times for a passenger being driven home from school. Content selection and delivery can then be tailored based upon the anticipated entry and exit times. In the case of a child being picked up from school, content over an hour in duration may not be recommended for an occupant whose anticipated exit time is less than hour. Other scenarios which account for anticipated entry and exit times are readily envisioned.

Navigational information retrieved, for example, from GPS device 16 can also be used to update the vehicle occupant map as indicated at 56. For instance, a vehicle's point of origination or destination may be used to designate the atmosphere during the trip (e.g., a sober atmosphere is designated when traveling to or from a funeral home). In another instance, an occupant's current interest may be correlated to topics related to the destination.

Lastly, the occupant map may track the current interests for each occupant. In a simplified embodiment, an overall user profile is maintained for each known occupant of the vehicle. Techniques for building such user profiles are readily known in the art. When a new occupant enters the vehicle, the user profile for the occupant is retrieved at 57 and used to update the current interest field in the occupant map as indicated at 58.

In a more robust embodiment, additional contemporaneous information may be used to determine an occupant's current interest. In some embodiments, the system may listen to conversations between vehicle occupants using in-vehicle microphones as indicated at 59. From these conversations, a current topic of interest can be determined and used to update the current interest field in the occupant map. In some embodiments, the system may query at 60 the mobile devices associated with an occupant. Recently accessed content or applications on the device may indicate the occupant's current interest. For example, was the occupant recently watching a news report on a current event? If so, the current interest field in the occupant map may be updated with the current event. Current interests may also be learned by querying a calendar on a personal mobile device for activities preceding or following occupancy in the vehicle. For example, if the occupant is scheduled to attend an upcoming music concert, then the occupant's current interests may include the artist featured at the concert.

With continued reference to FIG. 4, the relationship between occupants of the vehicle is evaluated at 42 and a designation of the relationship amongst occupants is provided for the vehicle. For example, when all of the occupants are family members, then the relationship amongst occupants is designated as ‘family’ or more specifically as either ‘immediate family’ or ‘extended family’. When occupants are identified as co-workers, then the relationship is designated as ‘co-workers’ or ‘business associates’. When one or more occupants are identified as minors or below a certain age (e.g., twelve), then the relationship is designated as ‘kid friendly’. Other types of designations are contemplated by this disclosure. Relationships amongst occupants may be further designated for a subset of seat positions. For example, the relationship between occupants in the front seats may be evaluated separately from occupants in the rear seats and a designation assigned to each subset of seat positions. This enables content recommendations and delivery to be targeted to a particular seat location, subset of seat positions or the entire vehicle compartment.

The commonality of interests amongst the occupants is also evaluated at 43. To so do, current interests for each occupant can be retrieved from the vehicle occupant map and compared to each other. When a current interest from one occupant matches or is substantially similar to a current interest of another occupant, the current interest is added to a list of common occupant interests. Each interest on the list may be further assigned a relevance rating indicative of how relevant the interest is to the vehicle occupants. In one embodiment, the relevance rating is assigned based on the number of occupants having this common interest. For example, an interest common to all occupants is assigned a rating of five, an interest common to all but one occupant is assigned a rating of four and so forth with an interest common to at least two occupants having a minimum rating of one. Activities currently occurring in the vehicle may also be added to the list and assigned a high priority rating. For example, if the occupants are already watching a particular movie or playing a particular game, this would constitute a current interest to the occupants and be added to the list.

Next, the listing of interests is translated at 44 into a listing of content recommendations. In a simplified embodiment, the listing of occupant interests is compared to a directory of available content. For instance, the vehicle may be equipped with a video player and an associated database of available content which is viewable via the video player by the vehicle occupants. When an entry in the list of occupant interests correlates closely with an entry in the database of available content, the correlated content, along with its relevance rating, is added to the listing of content recommendations. Techniques for correlating interests to a directory of available content are readily known in the art.

In other embodiments, recommendation engines may be used to generate a listing of content recommendations. Recommendation engines (and recommender systems) are known in the art, for example, commercially available from Panasonic Automotive Systems Company, Amazon.com, Google and others. These recommendation engines are implemented by the processor 14 from memory 15, and can be updated from time to time via the Internet. These recommendation engines take the context and history information and provide related output of automobile settings or related content. They use neural networks, statistical modeling, semantic analysis (including vectorial semantic analysis) and continuously update based on changing global criteria (such as weather patterns, road construction, and other related features). The vehicle can include multiple recommendation engines and give each hierarchy rankings based on user selections of outputs in the past. Further, companies providing the recommendation engine could pay the vehicle owner or manufacturer for the right or ability to be the recommendation engine of choice.

Formulating content suggestions can further include a combination of neural network for sensory input interpretation, relational database query, and rule based or probabilistic modeling of the satisfaction of each occupant to see what are the most likely options of car usage. Relational databases are used to intersect user's profiles and preferences and construct a set of items of interest, and the last pass is using a decision tree style rule based algorithm or a probabilistic satisfaction function maximization to select the best candidates for adapting the services/content rendered and the human interface through which they are rendered. Before presenting or otherwise implementing content recommendations in step 46, each recommendation is checked at 45 for potential conflicts.

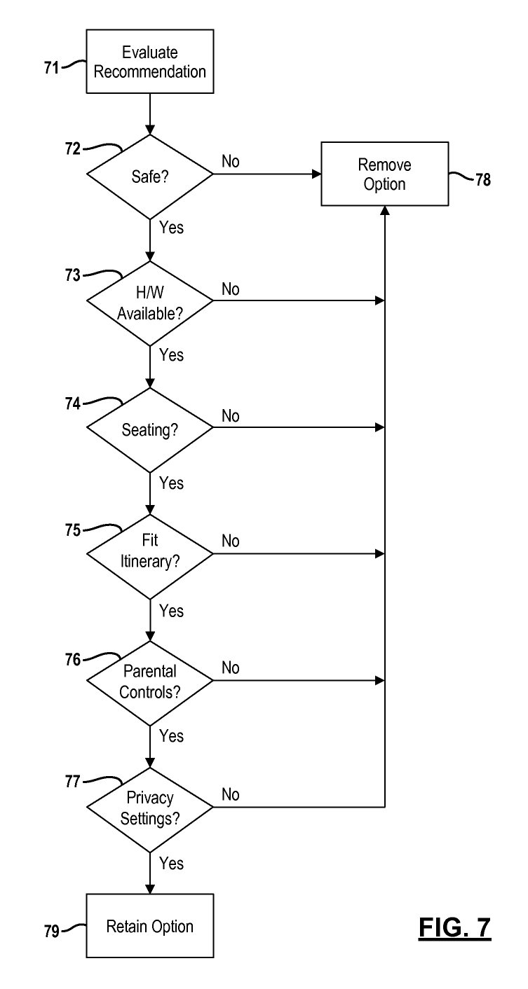

FIG. 7 depicts exemplary factors that may prevent content from being delivered to vehicle occupants. First, a particular recommendation may not be safely undertaken and thus is checked at 72 against the current vehicle conditions. For example, the driver may be prevented from participating in a game with other occupants when the vehicle is traveling above a certain speed or under adverse driving conditions (e.g., detected by vehicle rain sensors). In this case, the recommendation to play the game may be removed from the list of recommendations or modified to exclude invitation to the driver.

Second, a particular recommendation may not be supported by the available hardware in the vehicle as indicated at 73. For example, the recommendation to play a particular game may require that each participant have access to a keypad input. If one or more of the vehicle occupants does not have access to a keypad input (e.g., a person without an associated personal mobile device or sitting in the back seat), then the recommendation to play the game may be removed from the listing of recommendations.

Third, a particular recommendation may not be supported by the current seating arrangement of the occupants as indicated at 74. For example, the recommendation to play a game may dictate a preferred seating arrangement for the participants. For cooperative games, the participants may be required to sit next to each other, for example, in the back seat; whereas, other types of games, the participants may be separated from each other (i.e., one in front seat and one in rear seat). If the vehicle occupants are not arranged properly, the recommendation to play the particular game may be removed from the listing of recommendations.

Fourth, a particular recommendation may not be suitable for the known travel itinerary as indicated at 75. For example, the duration of a recommended movie may exceed the anticipated travel time to the destination. In another example, the occupant map may indicate that a child is expected to be entering the vehicle shortly. In this case, content recommendations not suitable children may be removed from the listing of recommendations.

Fifth, a particular recommendation may conflict with parental controls established by the vehicle owner as indicated at 76. For example, there may be a parental control that specifies only G rated movies or content may be delivered when the relationship amongst occupants is designated as family or kid-friendly. Content recommendations having a different rating would be removed the listing of recommendations. In another example, content delivery to a particular seat location or associated device(s) may be blocked based on such parental controls.

Similarly, a particular recommendation may conflict with privacy settings established by a vehicle occupant as indicated at 77. For example, there may be privacy settings that control delivery of email messages to the driver or another vehicle occupant. Email may be displayed on a center console when the relationship amongst the occupants is designated as family but directed to a headset worn by the driver or to the driver's mobile device when the relationship amongst the occupants is designated as business associates or something else other than family.

In an exemplary embodiment, conflict checking may be implemented using a rule-based approach, where one or more rules are defined for each conflict check. Each content recommendation is then compared at 71 against each of the conflict rules. When a particular recommendation does not comply with the rule, it may be removed from the list of content recommendations as indicated at 78 or some other corrective action may be taken to ensure compliance with the rule; otherwise, the recommendation is retained at 79 on the final listing of content recommendations. It is envisioned that each rule may further define one or more suggested corrective actions that can be taken when a given rule is not met. The vehicle owner may define a global set of rules which apply to the vehicle. Each vehicle occupant may further define rules that are applicable to themselves or to the vehicle when that occupant is the driver. While a few exemplary rules have been set forth above, it is readily understood that other types of conflict checks and associated rules fall within the scope of this disclosure.

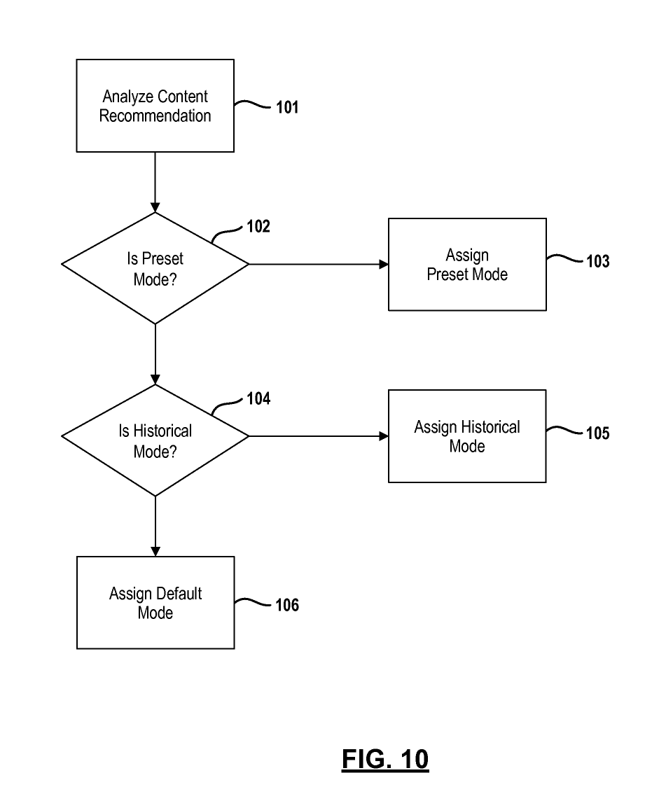

In a robust embodiment, content recommendations may be assigned a delivery mode as further described in relation to FIG. 10. First, each content recommendation is analyzed at 101 to determine what mode may apply to the content recommendation. This analysis will determine what vehicle settings are appropriate for implementing a given recommendation. For example, noise level in the vehicle should be low for content having an audio component; whereas, the noise level is not relevant for content having only a visual component. Exemplary vehicle settings may include but are not limited to volume, temperature, seat location of playing content, etc. This analysis may also evaluate what are the current vehicle settings (e.g., is radio on or HVAC fan on) as well as other contextual parameters (i.e., light conditions in or around the vehicle). Such context can be used when assigning a suitable mode for delivering content recommendations.

Each content recommendation is then checked at 102 against a repository of preset modes stored in the system. Each preset mode defines vehicle settings for implementing that mode. For example, preset modes related to delivering a movie may include an action mode and a relax mode. In the action mode, content is delivered to a display viewable to multiple occupants with the audio volume and display brightness set to high; whereas, in a relax mode, content may be delivered only to smaller displays individually associated with an occupant with the audio volume and display brightness set to low. In this way, the action mode creates a different environment within the vehicle for viewing the content than the relax mode.

For each preset mode, the vehicle settings are compared against the vehicle settings of a given content recommendation. If the vehicle settings are compatible, then the preset mode is assigned at 103 to the given content recommendation. To the extent that more than one preset mode is compatible with a given content recommendation, then each compatible present mode is associated with the content recommendation. That is, the content recommendation may be delivered in different ways (i.e., having different vehicle settings). Preset modes may be created and pre-installed in the system by the vehicle manufacturer. Alternatively, preset modes may be downloaded periodically to the vehicle from a source external (e.g., social network) to the vehicle.

Content recommendations are also checked at 104 against any historical modes stored in the system. Historical modes are delivery modes that have been previously implemented by the system and are typically defined by the vehicle owner; these historical modes also define vehicle settings and are assigned at 105 in the same manner as described above. If none of the preset or historical modes are compatible with a given content recommendation, then the content recommendation may be assigned a suitable default mode at 106. Default modes may be defined for the different types of content. That is, there may be a default modes for delivering music, movies, email, driving directions, etc.

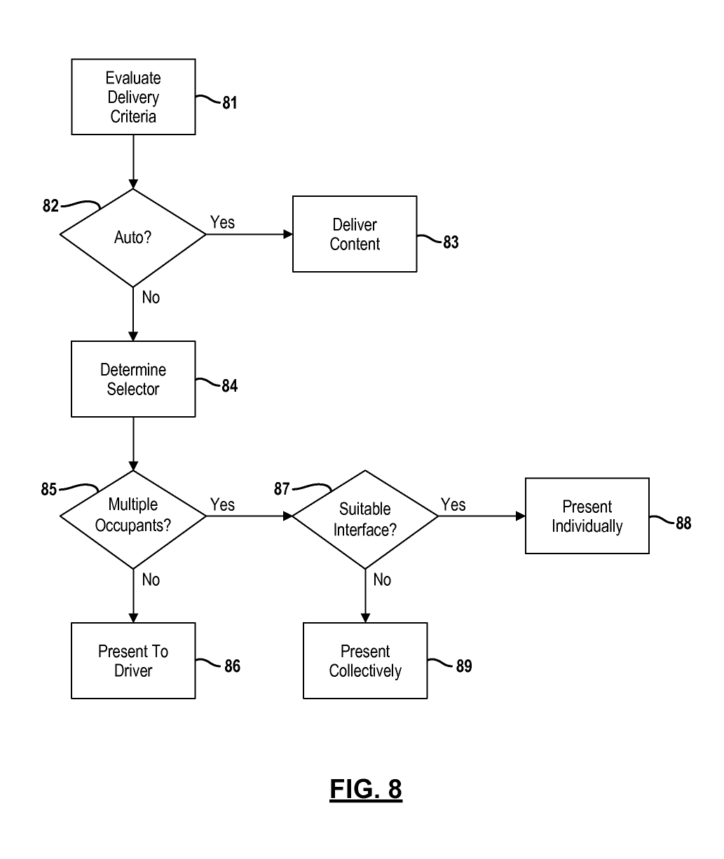

FIG. 8 further depicts an exemplary method for implementing one or more content recommendations. In one embodiment, the finalized listing of content recommendations serves as the input to the content deliver engine. The content delivery engine operates to evaluate the listing of content recommendations and deliver content to the vehicle occupants. It is understood that the listing is preferably sorted in accordance with the relevant rating associated with each recommendation. These hierarchy ratings could be based on public opinion (e.g. the online review of a restaurant), time left in the car ride, how many users were already using the content, the mood of the users compared to the genre of content, and other customizable hierarchy rating systems.

Content recommendations may be implemented automatically by the content delivery engine without input from the driver or another vehicle occupant under certain criteria as indicated at 82. For example, when the listing of content recommendations contains a single entry, the recommendation may be implemented automatically at 83 by the content delivery engine. Assuming all of the vehicle occupants have a common interest in jazz music, a corresponding recommendation to tune the radio to a local jazz station is implemented by the content delivery engine. In another example, two or more recommendations which are highly correlated to the interests of the vehicle occupants may be implemented automatically without input from the driver. Other criteria may be defined for implementing recommendations automatically without input from the vehicle occupants.

Conversely, the listing of content recommendations or a portion thereof may be presented for user selection. To do so, a determination is made at 84 as to whom will provide selection input. In some instances, only a single occupant is presented with the listing of recommendations as indicated at 86. For example, priority may be given to the driver, a parent regardless of seat location or the boss. Depending upon a privacy setting for the selector, options may be presented visually on a display in the center console or in a private manner such as audibly via a headset worn by the selector.

Alternatively, the listing of recommendations may be presented to two or more vehicle occupants. In this instance, the content delivery engine evaluates at 87 whether a suitable interface is available to present to the listing of recommendations to the vehicle occupants. Recommendations may be presented to occupants having a personal mobile device or another type of user interface (e.g., keypad and display) associated with their seat location. If such an interface is available for the applicable occupants, the listing of recommendation may be presented individually to each occupant as indicated at 88. It is understood that certain vehicle occupants may be excluded from those presented with recommendations (e.g., small children or infants). If an interface is not available for one or more of the applicable occupants, then the listing of recommendations is presented collectively to the occupants (e.g., on a shared display) as indicated at 89.

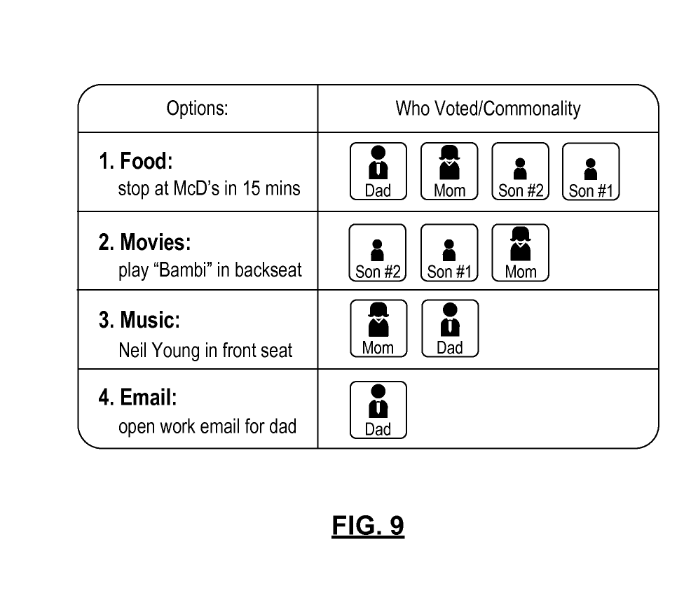

Occupants provide input as to which recommendations they prefer. Given input from the occupants, the content delivery engine 66 selects one or more options from the listing of recommendations. In one embodiment, the content delivery engine 66 selects the option receiving the most votes as shown in FIG. 9. The content delivery engine 66 may also implement more than one option if appropriate. For example, a movie may be played on a display located in the backset while music may be played on speakers positioned in the front seat. Moreover, the selection mechanism may weight input from some occupants, such as parents, more than other occupants, such as children. It is also noted that occupants may be permitted to provide input about recommendations which pertain to other occupants (e.g., a parent may vote for one movie over another movie intended for their children). Other types of selection mechanisms are contemplated by this disclosure. Finally, the content delivery engine 66 implements the selected content recommendations, vehicle mode adjustments (e.g. temperature, volume), destination re-route, and other related mode shifts.

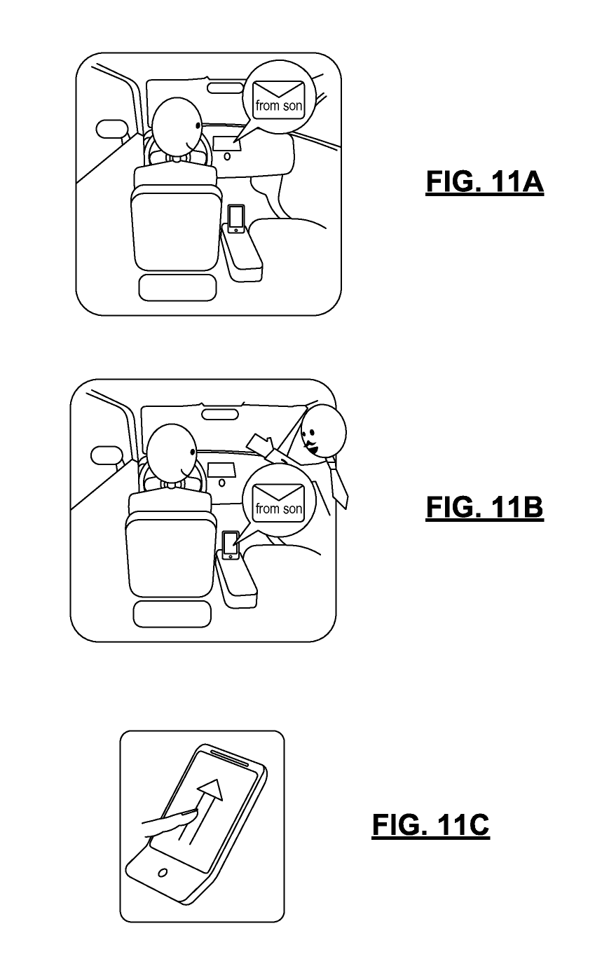

Privacy features are one important aspect of this system. Exemplary use cases are further described in relation to FIGS. 11A-11C. In this scenario, an email is displayed on the center console to the driver as shown in FIG. 11A. Subsequently, another occupant enters the vehicle. Depending upon the occupant's relationship with the driver, the delivery method for the email is changed by the control algorithm. For example, if the email message is from a family member of the driver but the occupant is not a family member, then the email message may be transferred automatically for display on a personal portable device associated with the driver as shown in FIG. 11B. In other example, the center console may support a dual view display, where the display tracks eyes movement of an occupant and directs the display towards the occupant for a private view of email messages. Alternatively, the email message may be synthesized into an audio ear piece worn by the driver or another occupant.

Continuing with the scenario above, the new occupant may not be recognized by the system but is recognized by the driver as a co-worker. If the driver is not concerned with privacy of the email message or would like to share the contents with the new occupant, the driver may supply a gesture command to the personal portable device (see FIG. 11C) or another input within the vehicle to transfer the email message back to the center console display.

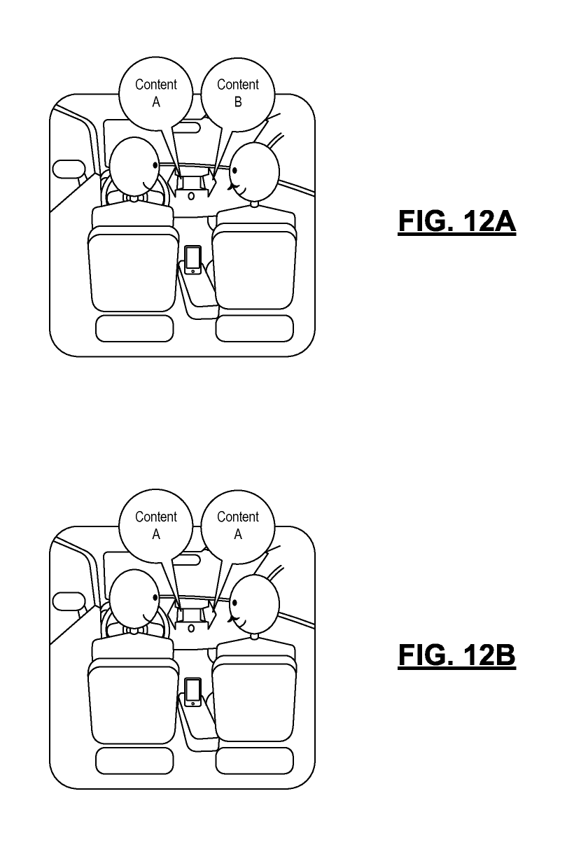

In another exemplary scenario, the driver and passenger may be viewing different context on a dual view display as shown in FIG. 12A or on two different displays. To share content, the driver may supply an input gesture command to transfer the content being viewed by the driver to the display being viewed by the passenger as shown in FIG. 12B.

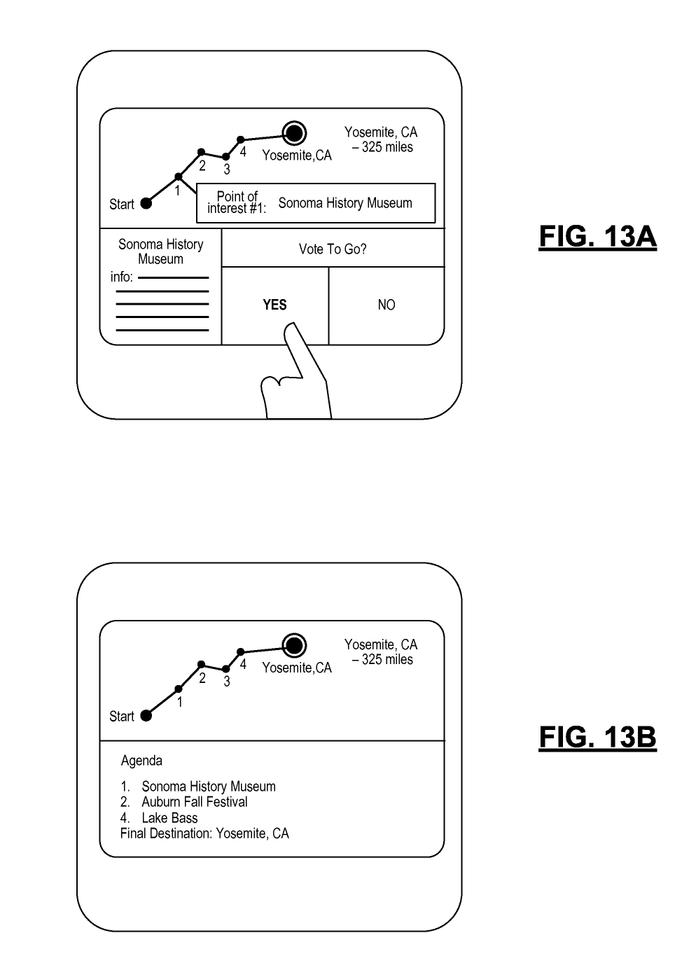

Location specific recommendation is another important aspect of this system. FIGS. 13A and 13B illustrate an exemplary use case of a family trip. Given a trip destination, the system may generate a listing of points of interests along the route to the destination. Alternatively, system may monitor searches made by occupants during the trip which pertain to points of interest along the route. In either case, a listing of the points of interest are presented to the vehicle occupants as shown in FIG. 13A. Vehicle occupants can vote or otherwise comment on the points of interest that are of interest to the occupant. Based on input from the occupants, an agenda is created and display to the occupants as shown in FIG. 13B.

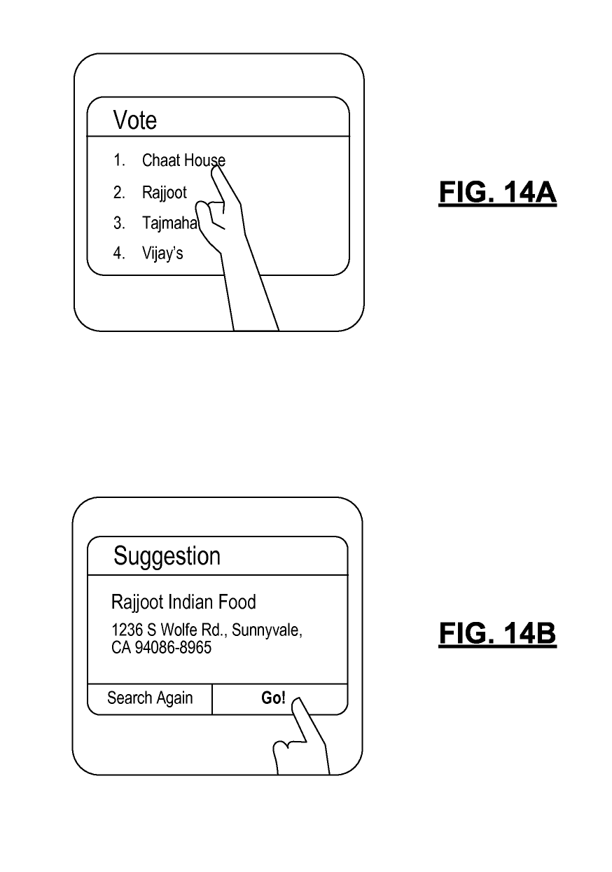

In another exemplary use case, the system may determine that a group of co-workers have entered the vehicle near lunch time. Given each occupant food or restaurant preferences as determined from their user profile, a listing of restaurant choices may be generated that is most appealing to the particular grouping of co-workers. The listing of restaurant is presented to the vehicle occupants as shown in FIG. 14A. Vehicle occupants can vote on which restaurant to dine at. Based on the occupant input, a final suggestion is presented to the vehicle driver as shown in FIG. 14B. Upon selecting the suggested restaurant, driving directions may be automatically provided by the system.

In yet another example, the group of co-workers may share a common client meeting which is learn by the system from an occupant's calendar. The meeting event on the calendar may further include a presentation document. Given the relationship between the occupants and the common interest in the meeting, the system can then operate to display the presentation on one more displays accessible to the vehicle occupants. Occupants could in turn edit, comment or rehearse the presentation while in the vehicle.

The ability to provide suggestions that cater to multiple users in a setting where the infotainment system can adapt to a single user experience or multiple experiences on individual mobile devices is an important aspect of this disclosure. Private content sessions provided by a car or third party through the car system is one way for the infotainment system to generate revenue and provide better or more useful connectivity than just the mobile device by itself.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An infotainment system for a vehicle, comprising:
one or more sensors disposed in the vehicle and operable to capture characteristic data regarding the occupants of the vehicle;
an occupant detector configured to receive characteristic data from the sensors and generate a profile for each occupant of the vehicle based on the characteristic data;
a recommendation engine configured to receive the profiles for the vehicle occupants and operable to analyze the profiles of the vehicle occupants; and
a content delivery engine operable to deliver content to one or more of the vehicle occupants in accordance with the analysis of the profiles of the vehicle occupants, wherein the recommendation engine and content delivery engine are implemented as computer readable instructions executed by a computer processor.

2. The infotainment system of claim 1 wherein at least one of the sensors is configured to detect a seat position of a given occupant in the vehicle.

3. The infotainment system of claim 1 wherein the occupant detector is configured to receive biometric data for a given occupant from one of the sensors and determine an identity for the given occupant from the biometric data.

4. The infotainment system of claim 3 wherein one sensor is further defined as a camera and the occupant detector determines at least one of presence or identity of the occupant from image data captured by the camera.

5. The infotainment system of claim 1 wherein the occupant detector is further configured to receive characteristic data for a given occupant from a mobile computing device in data communication with the infotainment system.

6. The infotainment system of claim 5 further comprises one or more docking stations for mobile computing devices, wherein the occupant detector determines a seat position for a given occupant from a data connection between a mobile computing device associated with the given occupant and one of the docketing stations.

7. The infotainment system of claim 1 wherein the occupant detector is further configured to receive characteristics data for a given occupant from a personal profile of the given occupant retrieved remotely from a data source outside the vehicle.

8. The infotainment system of claim 1 wherein the occupant detector is operable to determine a mood of a given occupant and the recommendation engine generates a recommendation for the content delivered by the infotainment system using the mood of the given occupant.

9. The infotainment system of claim 8 wherein the recommendation engine is operable to determine a route or destination of the vehicle and generate a recommendation for the content delivered by the infotainment system using the mood of the given occupant and the route or destination of the vehicle.

10. The infotainment system of claim 1 wherein the recommendation engine is operable to determine a route or destination of the vehicle and generate a recommendation for the content delivered by the infotainment system using the route or destination of the vehicle.

11. The infotainment system of claim 10 wherein the recommendation engine is further operable to generate the recommendation for the content using current location of the vehicle along the route.

12. The infotainment system of claim 10 wherein the recommendation engine is further operable to generate the recommendation for the content using time remaining until the vehicle reaches the destination.

13. The infotainment system of claim 1 wherein the recommendation engine is operable to determine a seat position for each occupant and the content delivery engine delivers content to one or more of the vehicle occupants in accordance with the seat positions of the vehicle occupants.

14. The infotainment system of claim 1 wherein the recommendation engine is operable to determine an interpersonal relationship between two or more occupants and determines a recommendation for the content delivered by the infotainment system in accordance with the interpersonal relationship.

15. The infotainment system of claim 1 wherein the recommendation engine is operable to determine an interpersonal relationship between the two or more occupants and the content delivery engine delivers content to one or more of the vehicle occupant in accordance with the interpersonal relationship.

16. The infotainment system of claim 1 wherein the occupant detector recommendation engine determines a current interest from a dialogue amongst vehicle occupants using speech recognition technology and recommendation engine generates a recommendation for the content delivered by the infotainment system using the current interest.

17. The infotainment system of claim 16 wherein the recommendation engine is operable to determine a route or destination of the vehicle and generate a recommendation for the content delivered by the infotainment system using the current interest and the route or destination of the vehicle.

18. The infotainment system of claim 1 wherein the content delivery engine changes content being delivered via the infotainment system in accordance with the interpersonal relationship.

19. The infotainment system of claim 1 wherein the content delivery engine changes delivery medium for content delivered by the infotainment system in accordance with the interpersonal relationship.

20. The infotainment system of claim 1 wherein the content delivery engine changes a setting of a vehicle subsystem based on the content being delivered.

21. A computer-implemented method for delivering content using an infotainment system in a vehicle, comprising:
capturing characteristics for two or more occupants of the vehicle using sensors disposed in the vehicle;
determining an identity for each occupant from the captured characteristics;
determining an interpersonal relationship between the two or more occupants of the vehicle; and
delivering content using the infotainment system in accordance with the interpersonal relationship between the occupants of the vehicle.

22. The method of claim 21 wherein capturing characteristics for the occupants includes determining a weight of the driver using a capacitive sensor.

23. The method of claim 21 further comprises determining characteristics for an occupant from a mobile computing device in data communication with the infotainment system.

24. The method of claim 21 further comprises determining characteristics for an occupant from a personal profile of the occupant retrieved from a data source outside the vehicle.

25. The method of claim 21 further comprises determining an interpersonal relationship by access a personal profile retrieved from a data source outside of the vehicle.

26. The method of claim 21 further comprises determining a current interest from a dialogue amongst the occupants using speech recognition technology and generating a content recommendation based on the current interest.

27. The method of claim 21 further comprises changing content delivery medium in accordance with the interpersonal relationship.

28. The method of claim 27 further comprises changing content delivery medium when a given occupant is unknown to a vehicle driver.

29. The method of claim 28 further comprises transferring content delivery from a medium accessible to the given occupant to a mobile device associated with the vehicle driver.

30. The method of claim 27 further comprises changing content delivery medium in accordance with an age of a given occupant.

31. The method of claim 21 further comprises changing content being delivered via the infotainment system in accordance with the interpersonal relationship.

32. The method of claim 31 further comprises changing content being delivered in accordance with an age of a given occupant.

33. The method of claim 21 further comprises recommending a change in the content being delivered via the infotainment system in accordance with the interpersonal relationship.
